(19) United States
(12) Patent Application Publication
(10) Pub. No.: US 2025/0328008 A1
(43) Pub. Date: Oct. 23, 2025

(54) IMAGING UNIT

(71) Applicants: Murata Manufacturing Co., Ltd., Nagaokakyo-shi (JP); MAXELL, LTD., Kyoto (JP)

(72) Inventors: Hitoshi SAKAGUCHI, Nagaokakyo-shi (JP); Yuuki ISHII, Nagaokakyo-shi (JP); Yuka TANAKA, Nagaokakyo-shi (JP); Yoshito YAMADA, Kyoto (JP); Junichi YOKOYAMA, Kyoto (JP); Shinji FUJITA, Kyoto (JP)

(21) Appl. No.: 19/259,289

(22) Filed: Jul. 3, 2025

Related U.S. Application Data
(63) Continuation of application No. PCT/JP2024/004288, filed on Feb. 8, 2024.

(30) Foreign Application Priority Data
Mar. 17, 2023 (JP) 2023-043361

(51) Int. Cl. G02B 27/00; H04N 23/51; H04N 23/54; H04N 23/55

(52) U.S. Cl. CPC G02B 27/0006; H04N 23/51; H04N 23/54; H04N 23/55

(57) ABSTRACT

An imaging unit that includes: a vibration device having a housing and configured to vibrate a light-transmitting element, the light transmitting element configured to transmit light having a predetermined wavelength; a sensor device including a bracket and an imaging element on the bracket; and a plurality of projections on at least one of the housing of the vibration device and the bracket of the sensor device, wherein the housing and the bracket are joined via the plurality of projections such that the light transmitting element is in a direction of view from the imaging element on the bracket.

### CROSS REFERENCE TO RELATED APPLICATIONS

The present application is a continuation of International application No. PCT/JP2024/004288, filed Feb. 8, 2024, which claims priority to Japanese Patent Application No. 2023-043361, filed Mar. 17, 2023, the entire contents of each of which are incorporated herein by reference.

### TECHNICAL FIELD

The present disclosure relates to an imaging unit.

### BACKGROUND ART

Safety device control and driving support control have been performed by providing an imaging unit at the front or the rear of a vehicle and by using images obtained in the imaging unit. Such an imaging unit is often provided at the outside of a vehicle, and thus foreign matter, such as raindrops (waterdrops), mud, or dust, sometimes adheres to a light-transmitting element (a protective cover or a lens) that covers the outside of the imaging unit.

When foreign matter adheres to the light-transmitting element, the foreign matter is reflected in images obtained in the imaging unit, and thus clear images cannot be obtained. Thus, U.S. Pat. No. 8,899,761 (Patent Document 1) describes an imaging unit including a vibration device configured to vibrate a light-transmitting element to remove foreign matter adhered to a surface of the light-transmitting element.
Patent Document 1: U.S. Pat. No. 8,899,761

### SUMMARY OF THE DISCLOSURE

In the imaging unit described in Patent Document 1, a sensor device including an imaging element is joined to a housing of the vibration device formed by bonding a cover glass (light-transmitting element), a metal, a piezoelectric element, and an insulating material together.

However, in the imaging unit described in Patent Document 1, vibrations of the vibration device leak to the sensor device from the part where the vibration device and the sensor device are joined to each other, thus impairing the performance of vibrating the light-transmitting element. Accordingly, there may be a case in which it is not possible to achieve a desired performance for removing foreign matter adhered to the surface of the light-transmitting element.

Accordingly, an object of the present disclosure is to provide an imaging unit that has a configuration in which a vibration device and a sensor device are joined to each other and that inhibits impairment in the performance of vibrating a light-transmitting element.

An imaging unit according to an aspect of the present disclosure includes: a vibration device having a housing and configured to vibrate a light-transmitting element, the light transmitting element configured to transmit light having a predetermined wavelength; a sensor device including a backet and an imaging element on the bracket; and a plurality of projections on at least one of the housing of the vibration device and the bracket of the sensor device, wherein the housing and the bracket are joined via the plurality of projections such that the light-transmitting element is in a direction of view from the imaging element on the bracket.

Another imaging unit according to an aspect of the present disclosure includes: a vibration device having a housing and configured to vibrate a light-transmitting element, the light transmitting element configured to transmit light having a predetermined wavelength; a sensor device including a bracket and an imaging element on the bracket; and a cushioning material joining the housing of the vibration device and the bracket of the sensor device are such that the light-transmitting element is in a direction of view from the imaging element on the bracket.

The present disclosure inhibits impairment in the performance of vibrating the light-transmitting element in the configuration in which the vibration device and the sensor device are joined to each other.

### BRIEF DESCRIPTION OF THE DRAWINGS

FIG. 1 is a perspective view of an imaging unit according to Embodiment 1.

FIG. 2 is a sectional view of the imaging unit according to Embodiment 1.

FIG. 3 is a perspective view of a vibration device according to Embodiment 1.

FIG. 4 is a half sectional view for describing vibrations of the vibration device according to Embodiment 1.

FIG. 5 is a graph for describing the relationship between a contact area and a vibration energy.

FIGS. 6(a) and 6(b) include perspective views of vibration devices according to modification examples of Embodiment 1.

FIGS. 7(a) and 8(b) include perspective views of brackets according to modification examples of Embodiment 1.

FIGS. 8(a) and 8(b) include perspective views of vibration devices having other shapes.

FIGS. 9(a) to 9(c) include perspective views of vibration devices on which cushioning materials are provided.

FIG. 10 is a sectional view of an imaging unit according to Embodiment 2.

FIGS. 11(a) to 11(c) are schematic views of an imaging unit according to a first modification example of Embodiment 2.

FIG. 12 is a sectional view of an imaging unit according to a second modification example of Embodiment 2.

FIG. 13 is a perspective view of an imaging unit according to Embodiment 3.

FIG. 14 is an exploded perspective view of the imaging unit according to Embodiment 3.

FIG. 15 is a perspective view of an imaging unit according to Embodiment 4.

FIG. 16 is a sectional view of the imaging unit according to Embodiment 4.

### DESCRIPTION OF THE PREFERRED EMBODIMENTS

Imaging units according to the present disclosure will be described in detail below with reference to the drawings. In the drawings, the same reference signs represent the same or corresponding parts. Each imaging unit described below is, for example, a vehicle-mounted imaging unit and is capable of vibrating a light-transmitting element (for example, an outermost lens) to remove foreign matter adhered to a surface of the light-transmitting element. The imaging unit is not limited to such a vehicle-mounted imaging unit. For example, the imaging unit is also applicable to, for example, a security surveillance camera and a drone.

### Embodiment 1

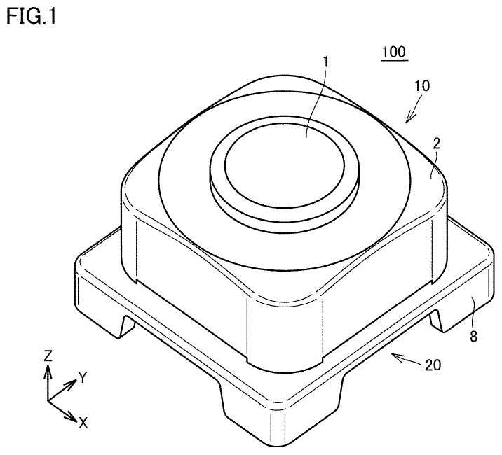

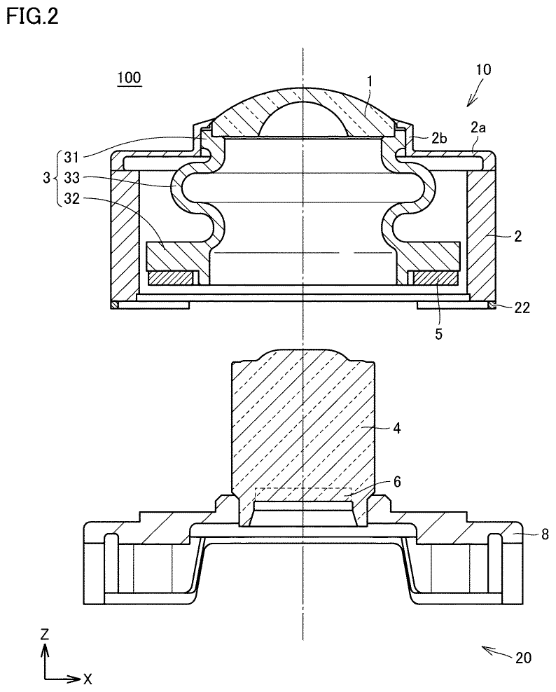

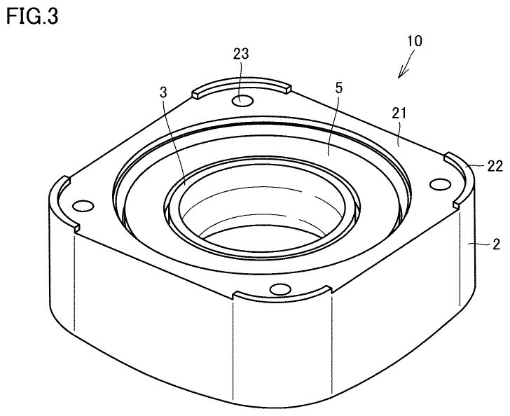

FIG. 1 is a schematic view of an imaging unit 100 according to Embodiment 1. FIG. 2 is a half sectional view of the imaging unit 100 according to Embodiment 1. FIG. 3 is a perspective view of a vibration device 10 according to Embodiment 1. In the drawings, the X direction, the Y direction, and the Z direction respectively represent a lateral direction, a depth direction, and a height direction of the imaging unit 100. A dashed line illustrated in FIG. 2 is a part passing through the central axis of the vibration device 10. The imaging unit 100 includes the vibration device 10 and a sensor device 20. The vibration device 10 includes an outermost lens 1, a housing 2, a vibrator 3, and a piezoelectric element 5. The sensor device 20 includes an inner lens 4, an imaging element 6, and a bracket 8.

After alignment between the outermost lens 1 and the inner lens 4, the sensor device 20 including the imaging element 6 is joined to the vibration device 10 to form the imaging unit 100. In the present embodiment, the configuration in which the sensor device 20 includes the inner lens 4 is described. However, the inner lens 4 may be provided to the vibration device 10. In addition, it is sufficient that the imaging unit 100 at least include the vibration device 10 configured to vibrate the outermost lens 1, the outermost lens configured to transmit light having a predetermined wavelength, and the sensor device 20 including the imaging element 6.

The imaging element 6 is an image sensor such as a charge coupled device (CCD) or a complementary metal-oxide-semiconductor (CMOS) sensor and is mounted on a circuit board (not illustrated). In addition to semiconductor elements such as a general-purpose integrated circuit (IC) or application specific integrated circuit (ASIC) configured to control the imaging element 6, for example, a semiconductor element configured to generate a signal for driving the piezoelectric element 5 may be mounted on the circuit board. The circuit board is fixed to the bracket 8 at a position where alignment between both the outermost lens 1 and the inner lens 4 and the imaging element 6 is performed. The bracket 8 is made of, for example, aluminum (A5052).

The outermost lens 1 is a light-transmitting element configured to transmit light having a predetermined wavelength (for example, a visible light wavelength or a wavelength of light that can be captured by using an imaging element). The outermost lens 1 is, for example, a borosilicate crown glass (BK7), a silica glass, a crown glass, a flint glass, or a convex meniscus lens. Instead of the outermost lens 1, a transparent member such as a protective cover may be used for the vibration device 10. The protective cover is made of glass or resin such as a transparent plastic.

An end portion of the outermost lens 1 is held by an end portion of a plate spring 2a extending from the housing 2. An adhesive is filled between the outermost lens 1 and a retainer 2b located at the end portion of the plate spring 2a. In addition, the vibration device 10 includes the vibrator 3 to vibrate the outermost lens 1 held by the housing 2. The housing 2 and the vibrator 3 are made of, for example, stainless steel (SUS304, SUS420, or SUS440).

As illustrated in FIG. 2, the vibrator 3 is a tubular body and is formed by a connection portion 31 (first portion) in contact with the outermost lens 1, a vibration portion 32 (second portion), on which the piezoelectric element 5 is provided, and a support portion 33 (third portion) connecting the connection portion 31 and the vibration portion 32. A sectional shape of the support portion 33 is an S shape. As illustrated in FIG. 2, the inner lens 4 is disposed in the tubular body of the vibrator 3.

The connection portion 31 has a cylindrical shape extending in the axial direction (Z direction) of the tubular body. An end portion of the connection portion 31 is shaped so as to extend in radial directions (X and Y directions) of the tubular body. Thus, the end portion of the connection portion 31 can be stably in contact with a peripheral portion of the outermost lens 1. The connection portion 31 may be formed only by the part extending in the axial direction (Z direction) of the tubular body or the part extending in the radial directions (X and Y directions) of the tubular body.

The vibration portion 32 is a portion configured to vibrate along with vibrations of the piezoelectric element 5. The thickness of the vibration portion 32 is larger than the thickness of each of the connection portion 31 and the support portion 33. This facilitates more efficient transmission of vibrations of the piezoelectric element 5 to the outermost lens 1.

The support portion 33 is a portion supporting the connection portion 31 and configured to transmit vibrations of the vibration portion 32 to the connection portion 31. The connection portion 31, the vibration portion 32, and the support portion 33 may be formed integrally with each other or separately from each other.

The piezoelectric element 5 is provided on a surface of the vibration portion 32 on the side opposite to the side in contact with the outermost lens 1. The piezoelectric element 5 has a hollow circular shape and vibrates by, for example, being polarized in the thickness direction. The piezoelectric element 5 is made of PZT-based piezoelectric ceramics. However, other piezoelectric ceramics made of, for example, (K, Na) NbO₃ may be used in the piezoelectric element 5. In addition, piezoelectric single crystals made of, for example, LiTaO₃ may be used in the piezoelectric element 5.

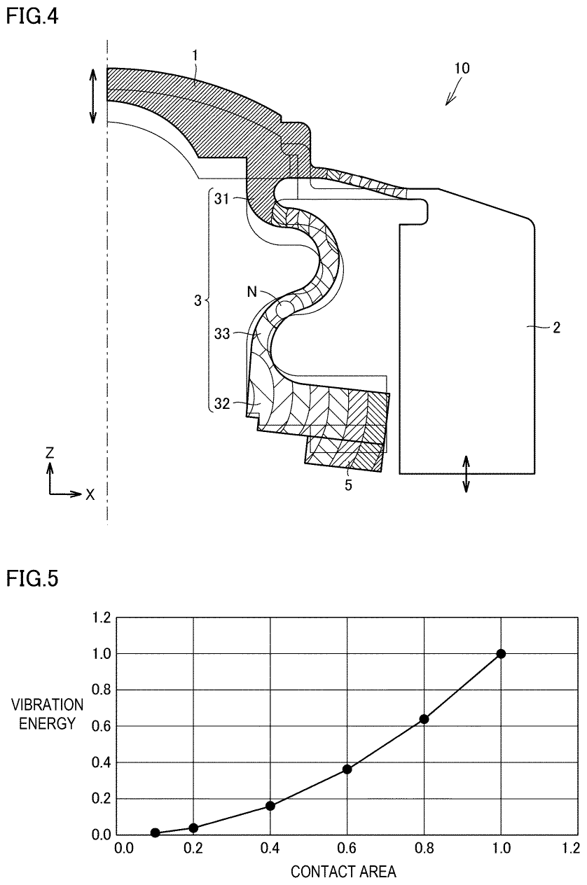

The piezoelectric element 5 having a hollow circular shape vibrates in radial directions, and the vibrations of the piezoelectric element 5 are converted into vibrations in the Z direction (an up-down direction in the figure) by the support portion 33 of the vibrator 3, thus vibrating the outermost lens 1 in the Z direction. FIG. 4 is a half sectional view for describing vibrations of the vibration device 10 according to Embodiment 1. An alternate long and short dashed line illustrated in FIG. 4 is a part passing through the central axis of the vibration device 10.

As is clear from FIG. 4, the vibrator 3 displaces the outermost lens 1 in the Z direction by elastic deformation of the support portion 33 like a spring. The plate spring 2a of the housing 2 holding the outermost lens 1 also elastically deforms due to vibrations of the vibrator 3. In addition, as is clear from FIG. 4, the vibrator 3 has a node N of vibrations at the center of the part of the support portion 33 whose sectional shape is an S shape. Vibrations of the vibrator 3 cause displacement of the outermost lens 1 to be maximum but cause displacement of the node N of vibrations to be small. In FIG. 4, the density of hatching represents the degree of displacement. Thus, dense hatching represents a greatly displaced part, and displacement of the outermost lens 1 is large.

Most of vibrations of the outermost lens 1 are absorbed due to elastic deformation of the plate spring 2a, and the remaining vibrations that are not absorbed are transmitted to the housing 2, thus vibrating the housing 2 in the Z direction. The vibrations of the housing 2 leak to the bracket 8 of the sensor device 20 joined to the vibration device 10. The vibration energy is taken away from the vibration device 10, thus damping the vibrations of the outermost lens 1. The vibrations that leak to the bracket 8 are about 2 to 3% of the vibrations of the outermost lens 1.

Accordingly, as illustrated in FIG. 3, in the vibration device 10, projections 22 are provided on a bottom surface 21 of the housing 2 to reduce the contact area where the vibration device 10 and the bracket 8 are in contact with each other. The projections 22 are provided at respective positions in the vicinities of screw holes 23 provided at the four corners of the housing 2. In addition, the projections 22 are continuous with a side surface of the housing 2 and are provided along the four corners. The housing 2 and the bracket 8 are joined via the projections 22 to reduce the contact area where the housing 2 and the bracket 8 are in contact with each other, thus damping the vibrations that leak from the housing 2 to the bracket 8.

FIG. 5 is a graph for describing the relationship between a contact area and a vibration energy. In FIG. 5, the horizontal axis represents the contact area where the housing 2 and the bracket 8 are in contact with each other, and the vertical axis represents the vibration energy that leaks to the bracket 8. In addition, the contact area and the vibration energy when the entire bottom surface 21 of the housing 2 is in contact with the bracket 8 are each normalized as 1. As is clear from the graph illustrated in FIG. 5, the vibration energy tends to increase as the contact area increases. Thus, it is clear that reducing the contact area where the housing 2 and the bracket 8 are in contact with each other is effective to damp the vibrations that leak from the housing 2 to the bracket 8.

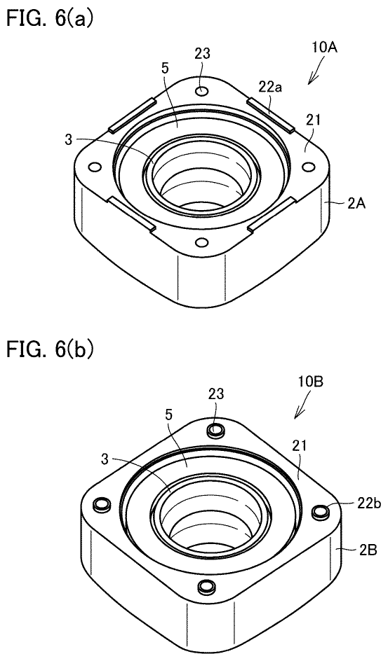

The shape of the projections 22 is not limited to the shape illustrated in FIG. 3 and may be any shape as long as it is possible to reduce the contact area where the housing 2 and the bracket 8 are in contact with each other. FIGS. 6(a) and 6(b) include perspective views of vibration devices 10A and 10B according to modification examples of Embodiment 1. In the vibration devices 10A and 10B, the same components as those of the vibration device 10 illustrated in FIG. 3 have the same reference signs, and the descriptions thereof are not repeated.

As illustrated in FIG. 6(a), in the vibration device 10A, projections 22a are provided on the bottom surface 21 of a housing 2A to reduce the contact area where the vibration device 10A and the bracket 8 are in contact with each other. The projections 22a are provided at respective positions between the screw holes 23 provided at the four corners of the housing 2A. In addition, the projections 22a are continuous with a side surface of the housing 2A and are provided along the four sides of the housing 2A.

As illustrated in FIG. 6(b), in the vibration device 10B, projections 22b are provided on the bottom surface 21 of a housing 2B to reduce the contact area where the vibration device 10B and the bracket 8 are in contact with each other. The projections 22b are provided at respective positions around the screw holes 23 provided at the four corners of the housing 2B. In addition, the projections 22b are provided so as to surround the screw holes 23.

The projections 22, 22a, and 22b are respectively formed integrally with the housings 2, 2A, and 2B but may be respectively formed separately from the housings 2, 2A, and 2B and thereafter joined to the housings. In addition, grooves may be formed in the bottom surface 21 of each of the housings 2, 2A, and 2B to form projections. In addition, the configuration in which each of the numbers of the projections 22, 22a, and 22b provided on the respective bottom surfaces 21 of the housings 2, 2A, and 2B is four has been described. However, it is possible to perform sufficient alignment between the sensor device 20 and the vibration devices 10, 10A, and 10B as long as each of the numbers of the projections 22, 22a, and 22b provided on the respective bottom surfaces 21 is at least three. In addition, the sensor device 20 and the vibration devices 10, 10A, and 10B are joined by joining the bracket 8 and the housings 2, 2A, and 2B via the projections 22, 22a, and 22b and by fixing the sensor device 20 and the vibration devices 10, 10A, and 10B with screws (a screw mechanism) from the bracket 8 side, respectively. However, the configuration is not limited thereto, and the sensor device 20 and the vibration devices 10, 10A, and 10B may be joined with an adhesive by joining the bracket 8 and the housings 2, 2A, and 2B via the projections 22, 22a, and 22b.

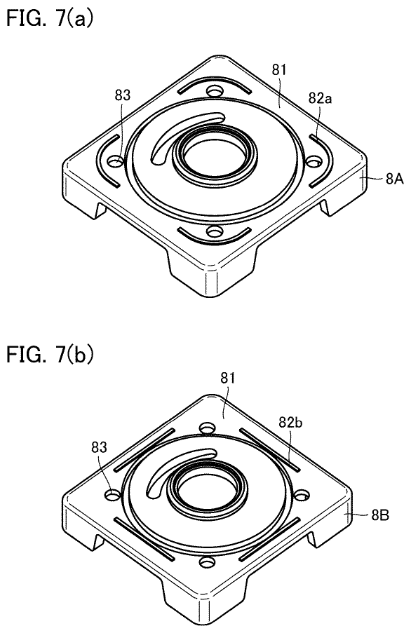

The projections are provided on the respective bottom surfaces 21 of the housings 2, 2A, and 2B of the vibration devices 10, 10A, and 10B but may be provided on the bracket 8. FIGS. 7(a) and 7(b) include perspective views of brackets 8A and 8B according to modification examples of Embodiment 1.

As illustrated in FIG. 7(a), in the bracket 8A, projections 82a are provided on a top surface 81 to reduce the contact area where the bracket 8A and the housing 2 are in contact with each other. The projections 82a are provided at respective positions in the vicinities of screw holes 83 provided at the four corners of the bracket 8A. In addition, the projections 82a are provided along the four corners of the bracket 8A.

As illustrated in FIG. 7(b), in the bracket 8B, projections 82b are provided on the top surface 81 to reduce the contact area where the bracket 8B and the housing 2 are in contact with each other. The projections 82b are provided at respective positions between the screw holes 83 provided at the four corners of the bracket 8B. In addition, the projections 82b are provided along the four sides of the bracket 8B.

The projections 82a and 82b are respectively formed integrally with the brackets 8A and 8B but may be respectively formed separately from the brackets 8A and 8B and thereafter joined to the brackets. In addition, grooves may be formed in the top surface 81 of each of the brackets 8A and 8B to form projections. In addition, the configuration in which each of the numbers of the projections 82a and 82b provided on the respective top surfaces 81 of the brackets 8A and 8B is four has been described. However, it is possible to perform sufficient alignment between the vibration device 10 and the sensor device 20 as long as each of the numbers of the projections 82a and 82b provided on the respective top surfaces 81 is at least three. In addition, the projections may be provided on one or both of the bottom surface of the housing and the top surface of the bracket.

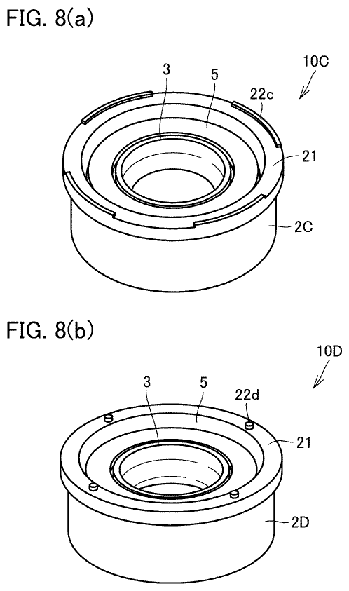

In the vibration devices 10, 10A, and 10B, the shape of each of the housings 2, 2A, and 2B is a quadrangular prism shape but is not limited to this shape. FIGS. 8(a) and 8(b) include perspective views of vibration devices 10C and 10D having other shapes. In the vibration devices 10C and 10D, the same components as those of the vibration device 10 illustrated in FIG. 3 have the same reference signs, and the descriptions thereof are not repeated.

As illustrated in FIG. 8(a), in the vibration device 10C, projections 22c are provided on the bottom surface 21 of a housing 2C having a cylindrical shape to reduce the contact area where the vibration device 10C and the bracket 8 are in contact with each other. The projections 22c are continuous with a side surface of the housing 2C and are provided at four respective positions along the circumferential direction of the housing 2C.

As illustrated in FIG. 8(b), in the vibration device 10D, projections 22d are provided on the bottom surface 21 of a housing 2D having a cylindrical shape to reduce the contact area where the vibration device 10D and the bracket 8 are in contact with each other. The projections 22d are provided at four respective positions on the bottom surface 21 of the housing 2D.

The shapes of the housings may be polygonal prism shapes such as a hexagonal prism shape and an octagonal prism shape in addition to a quadrangular prism shape and a cylindrical shape.

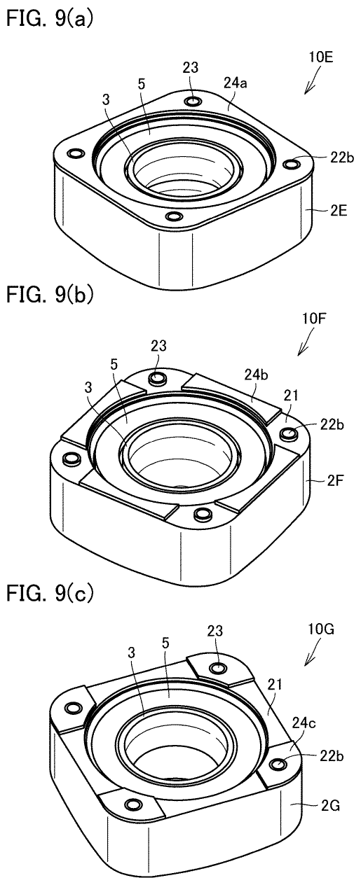

The bracket 8 and the housings 2, 2A, and 2B are joined via the projections 22, 22a, and 22b. Thus, a space is formed between the bracket 8 and the housings 2, 2A, and 2B and includes an air layer. A cushioning material may be provided in the space. FIGS. 9(a) to 9(c) include perspective views of vibration devices 10E to 10G on which cushioning materials are provided. In the vibration devices 10E to 10G, the same components as those of the vibration device 10 illustrated in FIG. 3 and the vibration devices 10A and 10B illustrated in FIGS. 6(a) and 6(b) have the same reference signs, and the descriptions thereof are not repeated.

As illustrated in FIG. 9(a), in the vibration device 10E, the projections 22b are provided on the bottom surface 21 of a housing 2E to reduce the contact area where the vibration device 10E and the bracket 8 are in contact with each other. The projections 22b are provided at respective positions around the screw holes 23 provided at the four corners of the housing 2E. In addition, the projections 22b are provided so as to surround the screw holes 23. In addition, a cushioning material 24a is provided on the entire part of the bottom surface 21 of the housing 2E on which the screw holes 23 and the projections 22b are not provided. The cushioning material 24a is, for example, resin, rubber, a liquid adhesive, or a gel adhesive. Compared with an air layer, the provision of the cushioning material 24a with a vibration damping property in a space between the housing 2E and the bracket 8 enables damping of vibrations that leak from the housing 2E to the bracket 8.

The cushioning material 24a is provided on the entire part of the bottom surface 21 of the housing 2E on which the screw holes 23 and the projections 22b are not provided. However, such a cushioning material may be provided as necessary on parts of the bottom surface 21 on which the screw holes 23 and the projections 22b are not provided. As illustrated in FIG. 9(b), in the vibration device 10F, cushioning materials 24b are provided at respective positions on the bottom surface 21 between the screw holes 23 provided at the four corners of a housing 2F. The cushioning materials 24b are provided along the four sides of the housing 2F. In addition, as illustrated in FIG. 9(c), in the vibration device 10G, cushioning materials 24c are provided at respective positions on the bottom surface 21 around the screw holes 23 provided at the four corners of the housing 26. The cushioning materials 24c are provided at the four corners of a housing 2G.

It is sufficient that such a cushioning material be disposed in the space between the housing and the bracket, and the cushioning material may thus be provided on the housing as illustrated in FIGS. 9(a) to 9(c) or on the bracket.

### Embodiment 2

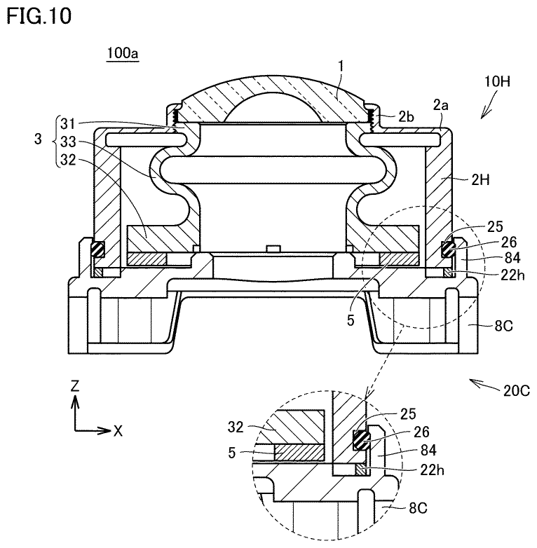

As described above, as illustrated in FIGS. 1 to 3, in the imaging unit 100 according to Embodiment 1, the housing 2 and the bracket 8 are joined via the projections 22, and the vibration device 10 and the sensor device 20 are fixed with screws from the bracket 8 side. In Embodiment 2, an imaging unit in which a vibration device and a sensor device are fixed by a fitting mechanism will be described. FIG. 10 is a sectional view of an imaging unit 100a according to Embodiment 2. In the imaging unit 100a, the same components as those of the imaging unit 100 illustrated in FIGS. 1 and 2 have the same reference signs, and the descriptions thereof are not repeated.

The imaging unit 100a includes a vibration device 10H and a sensor device 20C. The vibration device 10H includes the outermost lens 1, a housing 2H, the vibrator 3, and the piezoelectric element 5. The sensor device 20C includes the inner lens 4, the imaging element 6, and a bracket 8C. After alignment between the outermost lens 1 and the inner lens 4, the sensor device 20C including the imaging element 6 is joined to the vibration device 10H to form the imaging unit 100a. In the present embodiment, the configuration in which the sensor device 20C includes the inner lens 4 is described. However, the inner lens 4 may be provided to the vibration device 10H.

The bracket 8C includes a fixing portion 84 provided on and projecting from the surface of the bracket 8C joined to the vibration device 10H. The fixing portion 84 is formed so as to surround a side surface of the housing 2H and forms a recess when the bottom surface side of the housing 2H is a projection. That is, the vibration device 10H and the sensor device 20C are fixed by a fitting mechanism for fitting the projection located on the bottom surface side of the housing 2H into the recess formed by the fixing portion 84.

The inside of the fixing portion 84 and the side surface of the housing 2H may be formed so as to be directly in contact with each other. However, as illustrated in FIG. 10, in the imaging unit 100a, an O ring 26 is provided in a groove 25 provided in the side surface of the housing 2H, and the inside of the fixing portion 84 and the side surface of the housing 2H are in contact with each other via the O ring 26. The provision of the O ring 26 enables a reduction in vibration leakage from the side surface of the housing 2H to the inside of the fixing portion 84 and achievement of an effect of fixing the vibration device 10H and the sensor device 20C and a waterproof effect. The O ring 26 is made of a material such as silicone or nitrile rubber (NBR). The inside of the fixing portion 84 and the side surface of the housing 2H may be joined via, for example, a metal plate spring, a sponge, a rubber plate, or an adhesive instead of the O ring 26.

In the part where a bottom surface of the housing 2H and a top surface of the bracket 8C are joined to each other, as illustrated in Embodiment 1, projections 22h are provided on the bottom surface of the housing 2H. The bottom surface of the housing 2H and the top surface of the bracket 8C are joined to each other via the projections 22h to reduce the contact area where the housing 2H and the bracket 8C are in contact with each other, thus damping the vibrations that leak from the housing 2H to the bracket 8C. The shape of the projections 22h may be any shape as long as the shape is one of the shapes of the projections described in Embodiment 1. In addition, instead of the projections 22h provided on the bottom surface of the housing 2H, projections may be provided on the top surface of the bracket 8C.

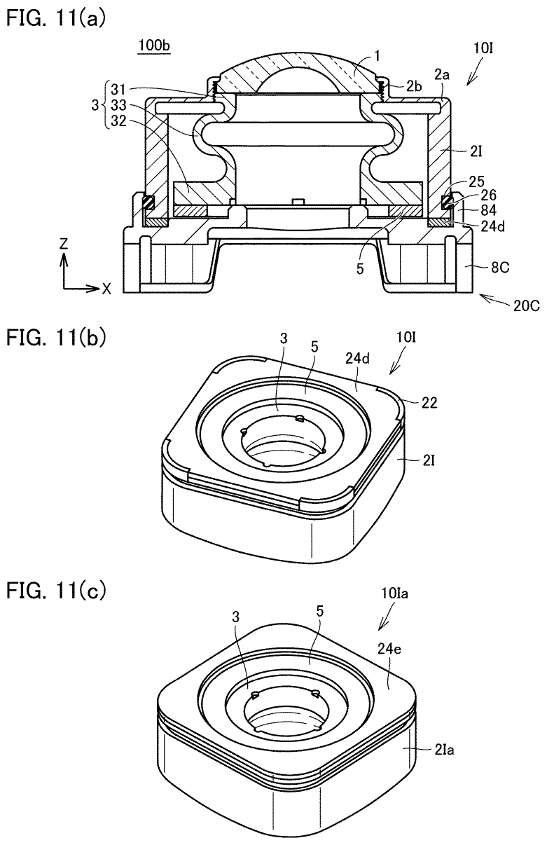

Next, a first modification example of Embodiment 2 will be described. FIGS. 11(a) to 11(c) are schematic views of an imaging unit 100b according to the first modification example of Embodiment 2. FIG. 11(a) is a sectional view of the imaging unit 100b. FIG. 11(b) is a perspective view of a vibration device 101. FIG. 11(c) is a perspective view of another vibration device 10Ia. In the imaging unit 100b, the same components as those of the imaging unit 100 illustrated in FIGS. 1 and 2 and the imaging unit 100a illustrated in FIG. 10 have the same reference signs, and the descriptions thereof are not repeated.

As illustrated in FIG. 10, in the imaging unit 100a according to Embodiment 2, the housing 2H and the bracket 8C are joined via the projections 22h. Thus, a space is formed between the housing 2H and the bracket 8C and includes an air layer. However, as illustrated in FIG. 11(a), in the imaging unit 100b according to the first modification example, a cushioning material 24d is provided in a space between a housing 2I and the bracket 8C. The cushioning material 24d is, for example, resin, rubber, a liquid adhesive, or a gel adhesive. Compared with an air layer, the provision of the cushioning material 24d with a vibration damping property in the space between the housing 21 and the bracket 8C enables damping of vibrations that leak from the housing 2I to the bracket 8C.

As illustrated in FIG. 11(b), in the vibration device 10I, the projections 22 are provided on a bottom surface of the housing 21. The projections 22 are provided at the four corners of the housing 21. In addition, the cushioning material 24d is provided on the entire part of the bottom surface of the housing 21 on which the projections 22 are not provided.

In the vibration device 101, the projections 22 are provided on the bottom surface of the housing 21. However, a vibration device in which no projections are provided on a bottom surface of a housing may be employed. As illustrated in FIG. 11(c), in another vibration device 10Ia, no projections are provided on a bottom surface of a housing 2Ia, and a cushioning material 24e is provided on the entire bottom surface of the housing 2Ia. The cushioning material 24e is, for example, resin, rubber, a liquid adhesive, or a gel adhesive.

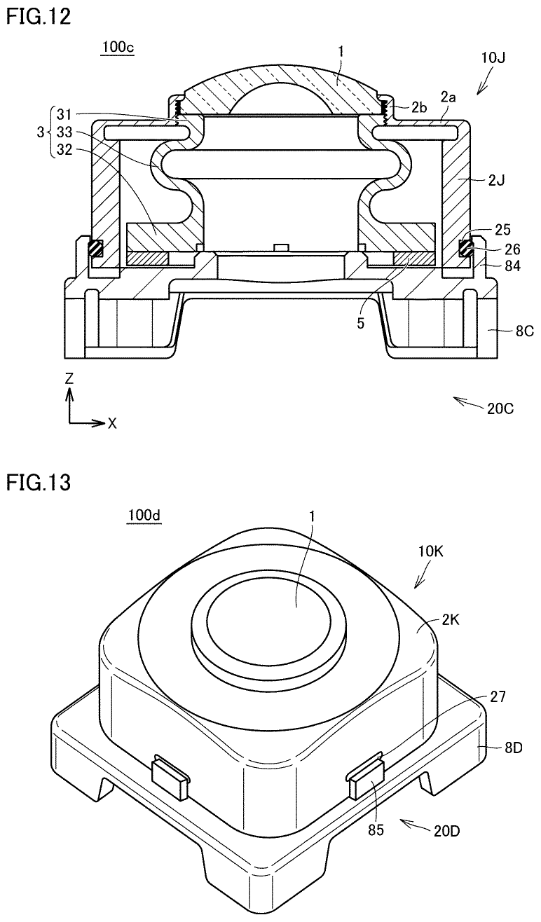

Next, a second modification example of Embodiment 2 will be described. FIG. 12 is a sectional view of an imaging unit 100c according to the second modification example of Embodiment 2. In the imaging unit 100c, the same components as those of the imaging unit 100 illustrated in FIGS. 1 and 2 and the imaging unit 100a illustrated in FIG. 10 have the same reference signs, and the descriptions thereof are not repeated.

As illustrated in FIG. 12, in the vibration device 10J, no projections and no cushioning material are provided on a bottom surface of a housing 2J. In the imaging unit 100c, the housing 2J and the bracket 8C are joined only via the fixing portion 84, and an air layer is formed between the bottom surface of the housing 2J and the top surface of the bracket 8C.

### Embodiment 3

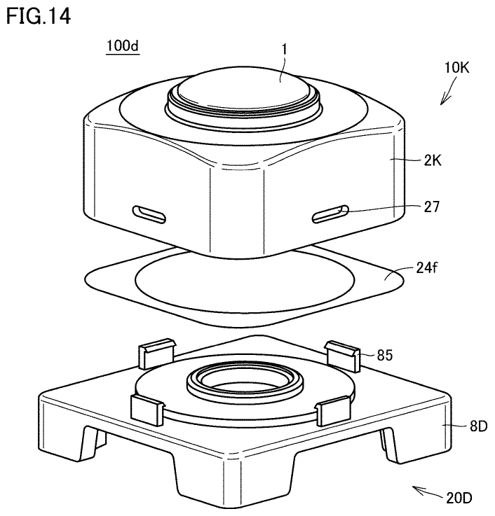

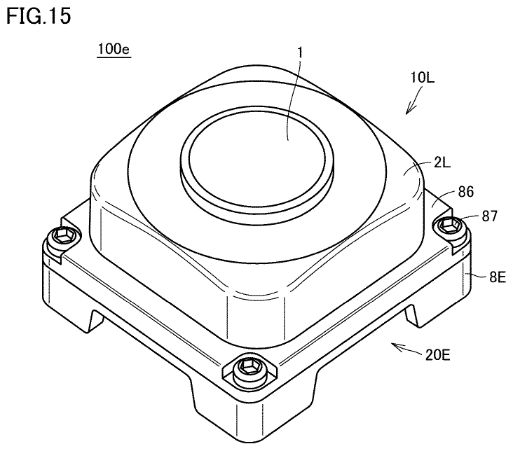

As described above, as illustrated in FIGS. 1 to 3, in the imaging unit 100 according to Embodiment 1, the housing 2 and the bracket 8 are joined via the projections 22, and the vibration device 10 and the sensor device 20 are fixed with screws from the bracket 8 side. In Embodiment 3, an imaging unit in which a vibration device and a sensor device are fixed by a snap-fit mechanism will be described. FIG. 13 is a perspective view of an imaging unit 100d according to Embodiment 3. FIG. 14 is an exploded perspective view of the imaging unit 100d according to Embodiment 3. In the imaging unit 100d, the same components as those of the imaging unit 100 illustrated in FIGS. 1 and 2 have the same reference signs, and the descriptions thereof are not repeated.

The imaging unit 100d includes a vibration device 10K and a sensor device 20D. The vibration device 10K includes the outermost lens 1, a housing 2K, the vibrator 3 (not illustrated), and the piezoelectric element 5 (not illustrated). The sensor device 20D includes the inner lens 4 (not illustrated), the imaging element 6 (not illustrated), and a bracket 8D. After alignment between the outermost lens 1 and the inner lens 4, the sensor device 20D including the imaging element 6 is joined to the vibration device 10K to form the imaging unit 100d. In the present embodiment, the configuration in which the sensor device 20D includes the inner lens 4 is described. However, the inner lens 4 may be provided to the vibration device 10K.

The bracket 8D includes claw portions 85 provided on and projecting from the surface of the bracket 8D joined to the vibration device 10K. The four claw portions 85 are provided so as to correspond to respective side surfaces of the housing 2K. However, it is sufficient that the number of the claw portions 85 to be provided be two or more. Recesses 27 configured to be engaged with the claw portions 85 are provided in the respective side surfaces of the housing 2K. In the imaging unit 100d, the vibration device 10K and the sensor device 20D are joined by engaging the claw portions 85 of the bracket 8D and the recesses 27 of the housing 2K with each other. The claw portions 85 of the bracket 8D and the recesses 27 of the housing 2K form the snap-fit mechanism that is a mechanical joining mechanism of the imaging unit 100d. The snap-fit mechanism is provided on the side surface side of the housing 2K but may be provided on the inside of the housing 2K.

As illustrated in FIG. 14, in the imaging unit 100d, a cushioning material 24f is provided in a space between the housing 2K and the bracket 8D. The cushioning material 24f is, for example, resin, rubber, a liquid adhesive, or a gel adhesive. In the imaging unit 100d, as described in Embodiment 1, projections may be provided on a bottom surface of the housing 2K or a top surface of the bracket 8D instead of the cushioning material 24f.

### Embodiment 4

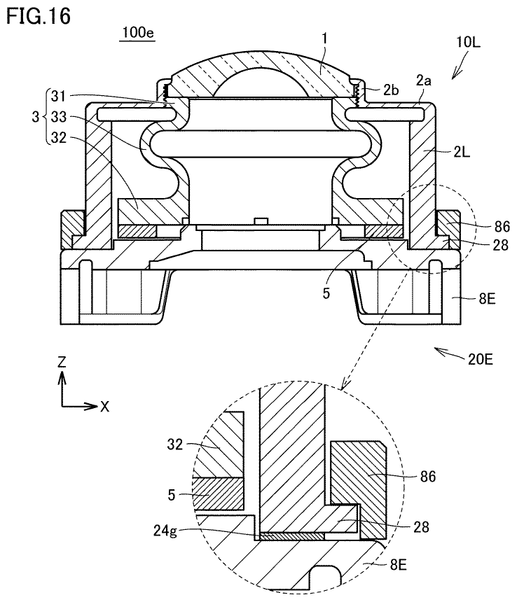

As described above, as illustrated in FIGS. 1 to 3, in the imaging unit 100 according to Embodiment 1, the housing 2 and the bracket 8 are joined via the projections 22, and the vibration device 10 and the sensor device 20 are fixed with screws from the bracket 8 side. In Embodiment 4, an imaging unit in which a vibration device and a sensor device are fixed by a holding mechanism will be described. FIG. 15 is a perspective view of an imaging unit 100e according to Embodiment 4. FIG. 16 is a sectional view of the imaging unit 100e according to Embodiment 4. In the imaging unit 100e, the same components as those of the imaging unit 100 illustrated in FIGS. 1 and 2 have the same reference signs, and the descriptions thereof are not repeated.

The imaging unit 100e includes a vibration device 10L and a sensor device 20E. The vibration device 10L includes the outermost lens 1, a housing 2L, the vibrator 3, and the piezoelectric element 5. The sensor device 20E includes the inner lens 4 (not illustrated), the imaging element 6 (not illustrated), and a bracket 8E. After alignment between the outermost lens 1 and the inner lens 4, the sensor device 20E including the imaging element 6 is joined to the vibration device 10L to form the imaging unit 100e. In the present embodiment, the configuration in which the sensor device 20E includes the inner lens 4 is described. However, the inner lens 4 may be provided to the vibration device 10L.

The bracket 8E includes a fixing portion 86 for holding the housing 2L of the vibration device 10L toward the sensor device 20E, and screws 87, with which the fixing portion 86 and the bracket 8E are joined. Four flange portions 28 are provided to the housing 2L in the vicinity of a bottom surface thereof so as to correspond to respective side surfaces of the housing 2L. The fixing portion 86 holds the housing 2L toward the sensor device 20E by holding the flange portions 28 between the fixing portion 86 and a top surface of the bracket 8E. The fixing portion 86 of the bracket 8E and the flange portions 28 of the housing 2L form the holding mechanism that is a mechanical joining mechanism of the imaging unit 100e.

The method for joining the fixing portion 86 and the bracket 8E is not limited to the method using the screws 87 and may be, for example, a different joining method using an adhesive. As described above, the four flange portions 28 are provided so as to correspond to the respective side surfaces of the housing 2L. However, it is sufficient that the number of the flange portions 28 to be provided be two or more. The flange portions 28 may be provided so as to surround the side surfaces of the housing 2L.

As illustrated in FIG. 16, in the imaging unit 100e, a cushioning material 24g is provided in a space between the housing 2L and the bracket 8E. The cushioning material 24g is, for example, resin, rubber, a liquid adhesive, or a gel adhesive. In the imaging unit 100e, as described in Embodiment 1, projections may be provided on a bottom surface of the housing 2L or a top surface of the bracket 8E instead of the cushioning material 24g.

### (Modification Examples)

Various joining methods for joining the vibration device and the sensor device in each imaging unit according to the above embodiments have been described. However, methods other than these joining methods may be used for joining. For example, in an imaging unit, a crimp portion is provided to a bracket and is bent to engage part of a housing of a vibration device and the crimp portion, thus joining the vibration device and a sensor device. The crimp portion of the bracket forms a crimping mechanism that is a mechanical joining mechanism of the imaging unit.

In addition, as described above, each bracket according to the above embodiments is made of, for example, aluminum (A5052). However, the material is not limited thereto. The part of the bracket joined to the housing may be made of a material for damping vibrations compared with the other parts (for example, an engineering plastic, resin such as rubber, or metal such as Kovar or stainless steel (SUS430)).

In addition, as described above, in each vibration device according to the above embodiments, a sectional shape of the support portion 33 is an S shape. However, the sectional shape of the support portion is not limited to such an S shape as long as the shape inhibits stress from being concentrated on the vibrator. The sectional shape of the support portion 33 may be, for example, a shape formed by connecting a plurality of S shapes or a curved shape that is a half S shape.

Each imaging unit according to the above embodiments may include a camera, LiDAR, or Radar. In addition, a plurality of imaging units may be disposed side by side.

Each imaging unit according to the above embodiments is not limited to an imaging unit provided to a vehicle. The present disclosure is also applicable to any imaging unit that is required to remove foreign matter adhered to a light-transmitting element and that includes an optical device and an imaging element from which the light-transmitting element is disposed in the direction of view.

### ASPECTS

(1) An imaging unit according to the present disclosure, comprising: a vibration device having a housing and configured to vibrate a light-transmitting element, the light transmitting element configured to transmit light having a predetermined wavelength; a sensor device including a backet and an imaging element on the bracket; and a plurality of projections on at least one of the housing of the vibration device and the bracket of the sensor device, wherein the housing and the bracket are joined via the plurality of projections such that the light-transmitting element is in a direction of view from the imaging element on the bracket.

Accordingly, in the imaging unit according to the present disclosure, the housing and the bracket are joined via the plurality of projections, thus inhibiting impairment in the performance of vibrating the light-transmitting element.

(2) The imaging unit according to (1), further comprising a cushioning material held in a space between the housing and the bracket.

(3) Another imaging unit according to the present disclosure, comprising: a vibration device having a housing and configured to vibrate a light-transmitting element, the light transmitting element configured to transmit light having a predetermined wavelength; a sensor device including a bracket and an imaging element on the bracket; and a cushioning material joining the housing of the vibration device and the bracket of the sensor device are such that the light-transmitting element is in a direction of view from the imaging element on the bracket.

Accordingly, in the imaging unit according to the present disclosure, the housing and the bracket are joined via the cushioning material, thus inhibiting impairment in the performance of vibrating the light-transmitting element.

(4) The imaging unit according to any one of (1) to (3), wherein the housing and the bracket are joined by an adhesive or a mechanical joining mechanism.

(5) The imaging unit according to (4), wherein the joining mechanism includes one of a screw mechanism, a fitting mechanism, a snap-fit mechanism, a holding mechanism, and a crimping mechanism.

(6) The imaging unit according to (5), wherein the snap-fit mechanism is on a side surface side of the housing.

(7) The imaging unit according to any one of (1) to (6), wherein a part of the bracket joined to the housing is made of a material that dampens vibrations relative to other parts of the bracket.

(8) The imaging unit according to any one of (1) to (7), wherein the vibration device includes: the light-transmitting element, the housing holding the light-transmitting element, a vibrator that vibrates the light-transmitting element held by the housing, and a piezoelectric element on the vibrator, the piezoelectric element configured to vibrate the vibrator, and the vibrator is a tubular body and includes, at a first end of the vibrator, a first portion in contact with the light-transmitting element or the housing, and, at a second end of the vibrator, a second portion having the piezoelectric element.

(9) The imaging unit according to (8), wherein the vibrator further includes a third portion connecting the first portion and the second portion, wherein a sectional shape of the third portion is a curved shape.

(10) The imaging unit according to (9), wherein the sectional shape of the third portion of the vibrator is an S shape.

(11) The imaging unit according to any one of (1) to (10), wherein the sensor device includes: the imaging element, the bracket fixing the imaging element, and an optical component having an optical axis in alignment with the imaging element, the optical component being fixed to the bracket.

The embodiments disclosed herein are illustrative in all aspects and should not be regarded as restrictive. The scope of the present disclosure is not defined by the above descriptions but is defined by the claims. The scope of the present disclosure is intended to include meanings equivalent to the claims and all modifications within the scope of the claims.

### REFERENCE SIGNS LIST

1 outermost lens
2, 2A to 2L housing
2a plate spring
2b retainer
3 vibrator
4 inner lens
5 piezoelectric element
6 imaging element
8, 8A to 8E bracket
10, 10A to 10L vibration device
20, 20C to 20E sensor device
21 bottom surface
22, 22a to 22d, 22 h, 82a, 82b projection
23 screw hole
24a to 24g cushioning material
25 groove
26 O ring
27 recess
28 flange portion
31 connection portion
32 vibration portion
33 support portion
81 top surface
84, 86 fixing portion
85 claw portion
87 screw
100, 100a, 100b imaging unit

1. An imaging unit comprising:
a vibration device having a housing and configured to vibrate a light-transmitting element, the light transmitting element configured to transmit light having a predetermined wavelength;
a sensor device including a backet and an imaging element on the bracket; and
a plurality of projections on at least one of the housing of the vibration device and the bracket of the sensor device, wherein
the housing and the bracket are joined via the plurality of projections such that the light-transmitting element is in a direction of view from the imaging element on the bracket.

2. The imaging unit according to claim 1, further comprising a cushioning material held in a space between the housing and the bracket.

3. The imaging unit according to claim 1, wherein the housing and the bracket are joined by an adhesive or a mechanical joining mechanism.

4. The imaging unit according to claim 3, wherein the joining mechanism includes one of a screw mechanism, a fitting mechanism, a snap-fit mechanism, a holding mechanism, and a crimping mechanism.

5. The imaging unit according to claim 4, wherein the snap-fit mechanism is on a side surface side of the housing.

6. The imaging unit according to claim 1, wherein a part of the bracket joined to the housing is made of a material that dampens vibrations relative to other parts of the bracket.

7. The imaging unit according to claim 1, wherein
the vibration device includes:
the light-transmitting element,
the housing holding the light-transmitting element,
a vibrator that vibrates the light-transmitting element held by the housing, and
a piezoelectric element on the vibrator, the piezoelectric element configured to vibrate the vibrator, and
the vibrator is a tubular body and includes, at a first end of the vibrator, a first portion in contact with the light-transmitting element or the housing, and, at a second end of the vibrator, a second portion having the piezoelectric element.

8. The imaging unit according to claim 7, wherein the vibrator further includes a third portion connecting the first portion and the second portion, wherein a sectional shape of the third portion is a curved shape.

9. The imaging unit according to claim 8, wherein the sectional shape of the third portion of the vibrator is an S shape.

10. The imaging unit according to claim 1, wherein
the sensor device includes:
the imaging element,
the bracket fixing the imaging element, and
an optical component having an optical axis in alignment with the imaging element, the optical component being fixed to the bracket.

11. An imaging unit comprising:
a vibration device having a housing and configured to vibrate a light-transmitting element, the light transmitting element configured to transmit light having a predetermined wavelength;
a sensor device including a bracket and an imaging element on the bracket; and
a cushioning material joining the housing of the vibration device and the bracket of the sensor device are such that the light-transmitting element is in a direction of view from the imaging element on the bracket.

12. The imaging unit according to claim 11, wherein the housing and the bracket are joined by an adhesive or a mechanical joining mechanism.

13. The imaging unit according to claim 12, wherein the joining mechanism includes one of a screw mechanism, a fitting mechanism, a snap-fit mechanism, a holding mechanism, and a crimping mechanism.

14. The imaging unit according to claim 13, wherein the snap-fit mechanism is on a side surface side of the housing.

15. The imaging unit according to claim 11, wherein a part of the bracket joined to the housing is made of a material that dampens vibrations relative to other parts of the bracket.

16. The imaging unit according to claim 11, wherein
the vibration device includes:
the light-transmitting element,
the housing holding the light-transmitting element,
a vibrator that vibrates the light-transmitting element held by the housing, and
a piezoelectric element on the vibrator, the piezoelectric element configured to vibrate the vibrator, and
the vibrator is a tubular body and includes, at a first end of the vibrator, a first portion in contact with the light-transmitting element or the housing, and, at a second end of the vibrator, a second portion having the piezoelectric element.

17. The imaging unit according to claim 16, wherein the vibrator further includes a third portion connecting the first portion and the second portion, wherein a sectional shape of the third portion is a curved shape.

18. The imaging unit according to claim 17, wherein the sectional shape of the third portion of the vibrator is an S shape.

19. The imaging unit according to claim 11, wherein
the sensor device includes:
the imaging element,
the bracket fixing the imaging element, and
an optical component having an optical axis in alignment with the imaging element, the optical component being fixed to the bracket.
